(19) United States
(12) Patent Application Publication
(10) Pub. No.: US 2015/0062873 A1
(43) Pub. Date: Mar. 5, 2015

(54) LIGHTING FIXTURE

(71) Applicant: John S. Berg, Franklin, MA (US)

(72) Inventor: John S. Berg, Franklin, MA (US)

(21) Appl. No.: 14/478,503

(22) Filed: Sep. 5, 2014

Related U.S. Application Data
(60) Provisional application No. 61/873,863, filed on Sep. 5, 2013.

(51) Int. Cl. F21V 31/00; F21V 29/00; F21K 99/00

(52) U.S. Cl. CPC F21V 31/005; F21K 9/30; F21V 29/22; F21Y 2101/02
USPC 362/101

(57) ABSTRACT

A high power, outdoor light fixture includes an enclosed, watertight housing shaped to define an interior cavity, a light source disposed within the interior cavity, an optical component for directing light produced by the light source out through a transparent region in the housing, a wirelessly accessible power source for supplying current to the light source, and an electrically insulating, thermally conductive, and transparent fluid, such as mineral oil, that substantially fills the interior cavity and submerges all components contained therein. The utilization of a liquid, rather than a gas, to fill the interior cavity eliminates internal pressure fluctuations within the fixture, thereby rendering the fixture safe and reliable for use in a wide range of environments. Additionally, any heat produced by the light source, or any additional interior components, is designed to be transferred to the thermally conductive housing via the liquid for efficient dissipation.

### FIELD OF THE INVENTION

The present invention relates generally to the lighting industry and more particularly to high-power, exterior lighting fixtures.

### BACKGROUND OF THE INVENTION

A lighting fixture, also commonly referred to simply as a light fixture or a light, is an electrical device that is commonly utilized to create artificial illumination. As can be appreciated, lighting fixtures are constructed in a wide array of different designs, with certain designs particularly well suited for use in specific environments.

A high power, exterior, lighting fixture is one type of lighting fixture that is well known in the art. A high power, exterior, light fixture typically includes, among other things, an enclosed outer housing, a light source (e.g., at least one light-emitting diode (LED)) disposed within the enclosed outer housing, wiring for electrically connecting the light source to a power source, and a switch for regulating the flow of current from the power source to the light source. In use, illumination from the light source is directed through a transparent window in the outer housing, often with the aid of one or more optical components, to create externally visible light.

Due to its relatively enclosed construction, exterior (i.e., outdoor) lighting fixtures of the type as described above can be utilized in environments that are subject to potentially hazardous conditions, such as extreme temperature variations, humidity fluctuations, exposure to precipitation, such as rain and snow, and even direct immersion in water. As such, high power, exterior light fixtures are commonly used in outdoor architectural, landscape and fountain lighting applications that require high light output (e.g., to illuminate building exteriors, gardens, walkways, pools and the like).

Although well known in the art, high power exterior light fixtures of the type as described above have been found to suffer from a notable drawback. Specifically, the light source in the fixture typically generates heat when activated. Accordingly, the act of switching the fixture on and off during routine use causes rapid cycles of heating and cooling within the housing which, in turn, causes the air sealed within the housing to expand and contract, respectively, in response thereto. If the expansion and contraction of the sealed air exceeds a particular threshold, the light fixture can potentially explode or implode, which not only results in the permanent inoperability of the fixture but also a potentially destructive condition.

Additionally, it has been found that the change in pressure within the housing can cause external air to be drawn into the interior of the housing through any wiring that is connected to an externally located power source (i.e., in a similar fashion to the application of suction force through a straw, with the wiring functioning as the straw). Even lighting fixtures with adequately sealed outer housings have been found to draw external air into its interior cavity. Moisture present in the external air (e.g., on a particularly humid day) that is drawn into the interior of the outer housing condenses as the air cools (e.g., from changes in the ambient temperature or through deactivation of the light source). As a result, a considerable amount of water often collects within the interior of the fixture.

Approximately half of all outdoor light fixtures currently in use accumulate moisture within its housing. This collection of water within the interior of the lighting fixture can ultimately result in permanent inoperability of the fixture, either through power supply failure, shorting of the electrical circuitry or, in certain circumstances, catastrophic explosion.

To remedy the aforementioned effects, outdoor light features are often provided with protective means to treat routine variances in the interior air pressure.

As an example, outdoor light fixtures are often provided with check valves to equalize pressure within the housing. However, although effective in minimizing the risk of fixture implosion and explosion, check valves have been found to be inadequate in preventing the condensation of moisture within the fixture housing.

As another example, outdoor light fixtures are often provided with vapor passing breathers, which allow for vapor to be repeatedly drawn into and expelled out from the housing. Through repetition of this cyclical process, the light fixture ultimately breathes the interior of the housing dry. However, although useful in certain circumstances, vapor passing breathers have been found to be ineffective in selected environments, such as in underwater lighting applications. In fact, there is currently no adequate protective measure for minimizing the accumulation of moisture in underwater light fixtures, other than the utilization of water tight seals and routine maintenance.

Lastly, it should be noted that although the aforementioned means for regulating interior air pressure within a light fixture can be somewhat effective, it has been found that the constant stress applied to any fixture seals as a result of the fluctuations in air pressure between the interior and exterior of the housing can cause the seals to dry out and shrink. This decrease in the volume of the seals, in turn, can result in the leakage of air therethrough. In hazardous locations where high concentrations of flammable gasses (e.g., hydrocarbons), vapors, or dusts occur (e.g., a Zone 0 area where flammable gasses or vapors are continuously present), any leakage of air through a seal in the fixture housing can result in a potentially catastrophic reaction.

### SUMMARY OF THE INVENTION

It is an object of the present invention to provide a new and improved lighting fixture.

It is another object of the present invention to provide a new and improved lighting fixture that generates high-power light and that is particularly well suited for use in a wide range of outdoor environments including submersion in water.

It is yet another object of the present invention to provide a lighting fixture as described above that is less susceptible to variances in pressure within its housing.

It is still another object of the present invention to provide a lighting fixture as described above that is less susceptible to the collection of water content within its housing.

It is yet still another object of the present invention to provide a lighting fixture as described above that has a limited number of parts, is inexpensive to manufacture and is simple to use.

Accordingly, as a feature of the present invention, there is provided a lighting fixture comprising (a) a housing shaped to define an interior cavity, the interior cavity having a volume, (b) a light source for producing light, the light source being disposed within the interior cavity, and (c) an electrically insulating, thermally conductive, and transparent liquid that substantially fills the interior cavity.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a top perspective view of a light fixture constructed according to the teachings of the present invention;

FIG. 2 is a simplified section view of the light fixture shown in FIG. 1 taken along lines 2-2, the fixture being shown producing light; and

FIG. 3 is a top perspective view, broken away in part, of a modification to the outer housing shown in FIG. 1.

### DETAILED DESCRIPTION OF THE INVENTION

### Construction of Light Fixture 11

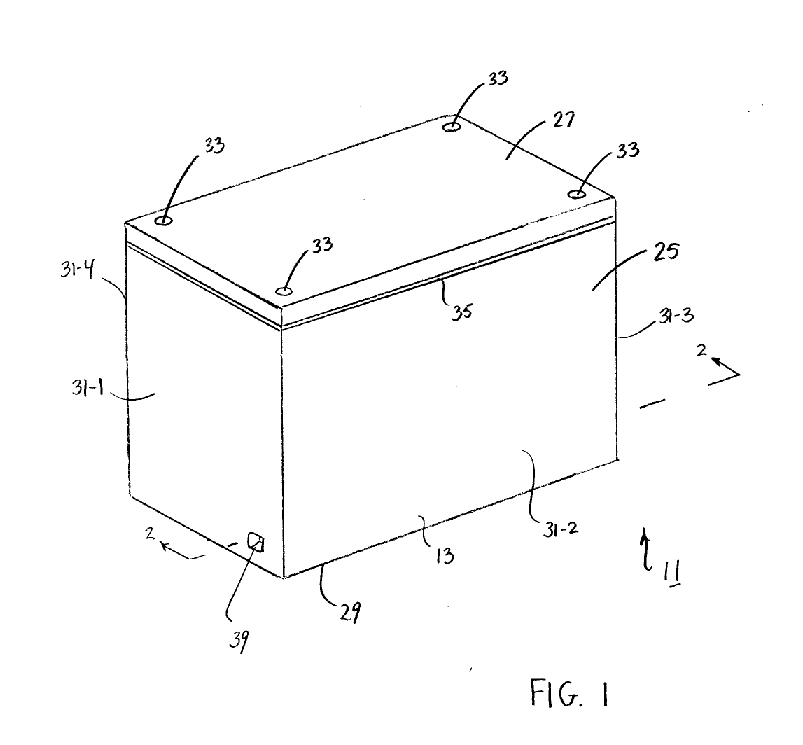

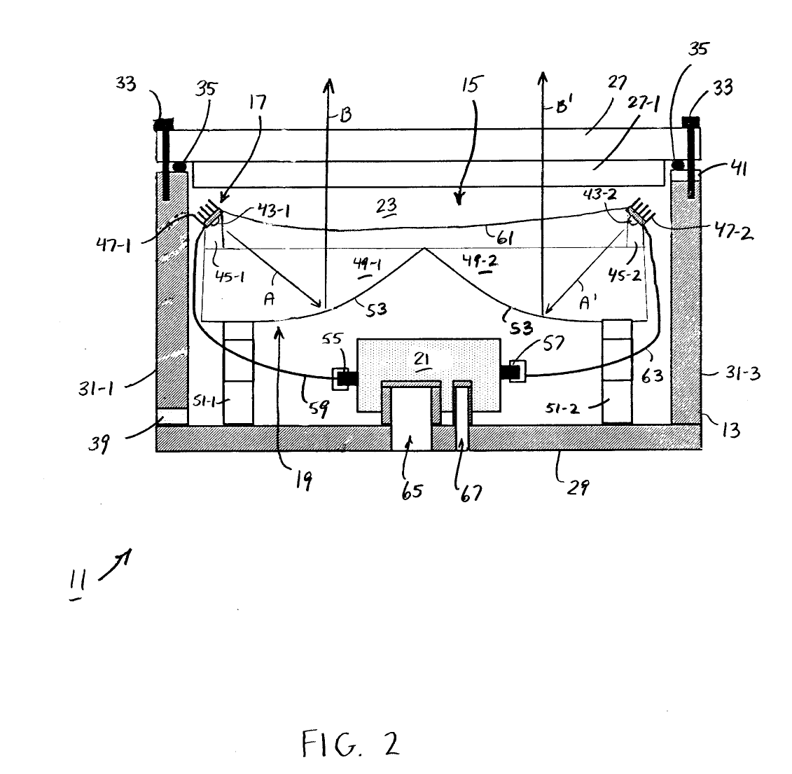

Referring now to FIGS. 1 and 2, there are shown top perspective and section views, respectively, of a lighting fixture constructed according to the teachings of the present invention, the lighting fixture being identified generally by reference numeral 11. As will be described in detail below, lighting fixture 11 is specifically designed, inter alia, to minimize (i) fluctuations in interior pressure, and (ii) the accumulation of water content therein. As such, lighting fixture 11 is particularly well suited for outdoor use in a wide range of environmental conditions, including submersion in water, which is a principal object of the present invention.

Lighting fixture, or fixture, 11 comprises an outer housing 13 shaped to define an interior cavity 15, a light source 17 disposed within interior cavity 15, an optical component 19 disposed within interior cavity 15 for treating light produced by light source 17, a power source 21 disposed within interior cavity 15 for supplying current to light source 17, and an electrically insulating, thermally conductive, and transparent liquid 23 that substantially fills interior cavity 15 and submerges light source 17, optical component 19 and power source 21.

Outer housing, or casing, 13 is constructed as a block-like enclosure that protects the various components retained therein. Outer housing 13 is represented herein as comprising an open box-shaped base 25 and a removable, generally planar cover 27 that together define enlarged, enclosed, interior cavity 15.

Base 25 is preferably constructed out of any suitable rigid, durable and thermally conductive material, such as metal or a thermally conductive plastic, and includes a generally rectangular, planar bottom wall 29 and four upstanding sidewalls 31-1 thru 31-4 which extend orthogonally up from the outer periphery of bottom wall 29 (i.e., along its free edges) so as to define interior cavity 15. As will be explained further in detail below, the thermally conductive construction of base 25 serves to draw heat retained by liquid 23 in cavity 15, primarily from light source 17, to its exposed external surfaces for cooling (e.g., by ambient air).

Cover 27 is a generally planar member that is preferably constructed out of any suitable rigid, durable and transparent material, such as a clear plastic. Cover 27 is dimensioned to overlie the open top wall of base 25 and includes a downwardly projecting, block-like portion 27-1 that fittingly projects between the distal ends of sidewalls 31-1 thru 31-4 so as to enclose interior cavity 15.

A plurality of fastening elements 33, represented herein as screw fasteners, is driven vertically downward through cover 27, at various locations along its periphery, and into sidewalls 31 to permanently secure cover 27 onto base 25. In addition, one or more compression gaskets 35 are disposed between cover 27 and sidewalls 31 to create a watertight seal therebetween. Furthermore, although not shown herein, at least a portion of the exterior of housing 13 is preferably applied with an optically transmissible, static dissipative coating. In this capacity, housing 13 can be assembled into a unitary, watertight, and static dissipative enclosure.

Housing 13 is additionally preferably provided with a fluid inlet port 39 and an air pressure port 41, the function of each port to become apparent in detail below. Inlet port 39 is in the form of a small one-way valve that extends transversely through sidewall 31-1 in close proximity to bottom wall 29. Air pressure port 41 is in the form of a small one-way valve that extends transversely through sidewall 31-3 in close proximity to cover 27 (i.e., at the highest location within interior cavity 15).

It should be noted that the construction of housing 13 could be modified to more adequately suit the needs of the intended application. For instance, it is to be understood that the particular size, shape and/or number of separable pieces for housing 13 could be modified without departing from the spirit of the present invention. As another example, it is to be understood that the transparent region in housing 13 could be relocated, increased (e.g., to include additional walls) or decreased (e.g., limited to a small window formed in cover 27) without departing from the spirit of the present invention.

As referenced briefly above, a light source 17 is disposed within interior cavity 15 and serves to produce artificial illumination. In the present embodiment, light source 17 is represented as first and second light emitting diodes (LEDs) 43-1 and 43-2. However, it is to be understood that the number and particular type of lights utilized to form light source 17 could be modified without departing from the spirit of the present invention.

LEDs 43-1 and 43-2 are fixedly mounted on support blocks 45-1 and 45-2, respectively, which are located within interior cavity 15 in close proximity to opposing sidewalls 31-1 and 31-3, respectively, of housing 13. Each support block 45, which is preferably constructed of an electrically insulated and minimally thermally conductive material, is coupled to housing 13 via optical component 19. Accordingly, each support block 45 serves to securely retain and orientate its associated light-emitting diode 43 such that light generated therefrom projects downward and inward towards optical component 19 at an angle of approximately 45 degrees.

Heat sinks 47-1 and 47-2 are mounted directly on LEDs 43-1 and 43-2, respectively. Each heat sink 47 is preferably constructed as a unitary block of thermally conductive material, such as metal, that includes a plurality of parallel fins to assist in heat dissipation, as will be explained further below.

Optical component 19 is preferably constructed as a unitary member that is fixedly disposed within interior cavity 15. Optical component 19 includes a pair of bulk optical elements 49-1 and 49-2 that are fixedly spaced way from bottom wall 29 of base 25 by corresponding vertical mounting blocks 51-1 and 51-2, respectively. As can be seen in FIG. 2, optical elements 49-1 and 49-2 are arranged as mirror images of one another.

The underside of each optical element 49 includes a parabolic reflective surface 53. As will be explained further in detail below, reflective surface 53 directs light produced by LEDs 43 out though transparent cover 27.

As referenced briefly above, power source 21 is responsible for supplying current to light source 17. In the present embodiment, power source 21 is disposed within interior cavity 15 and is permanently affixed to the inner surface of bottom wall 29. However, it is to be understood that power source 21 could be disposed at an alternative location within housing 13 without departing from the spirit of the present invention. For example, power source 21 could be alternatively affixed to the interior of one or more of sidewalls 31 and cover 27. In fact, it is envisioned that power source 21 could be mounted onto the exterior of housing 13 or even located remotely from fixture 11 without departing from the spirit of the invention.

Power source 21 represents any suitable device for storing energy, such as a battery, and includes a positive terminal 55 and a negative terminal 57. A first conductive element, such as a wire, 59 electrically connects positive terminal 55 to first LED 43-1. A second conductive element, such as a wire, 61 electrically connects LED 43-1 to LED 43-2. Lastly, a third conductive element, such as a wire, 63 electrically connects LED 43-2 to negative terminal 57. As such, LEDs 43-1 and 43-2 are connected in series and together form a daisy chain connection scheme with power source 21. In this manner, current can be delivered from power source 21 to LEDs 43-1 and 43-2 in an energy-efficient manner.

To control the operation and recharging of power source 21, bottom wall 29 is provided with a charging port 65 and a control port 67 in close proximity to power source 21. In the present embodiment, each of charging port 65 and control port 67 is represented as an externally accessible opening that is enclosed at its interior end so as to prevent the passage of liquid 23 therethrough. However, the thickness of the enclosed end of each of port 65 and 67 is limited to enable the control and the transfer of energy into power source 21 to be achieved in a wireless fashion. In other words, external control and energy transfer with power source 21 can be achieved without direct penetration through housing 13 with an external wire. As a result, fixture 11 is a modular unit that remains completely sealed.

For instance, energy may be inductively applied to power source 21 by disposing a conductive coil (not shown) inside charging port 65. The generation of an alternating field by the conductive coil would excite a corresponding resonant circuit in power source 21, thereby resulting in an efficient, wireless delivery of energy to power source 21. In a similar fashion, a control signal may be applied to power source 21 through inductive coupling (or even through the delivery of an optical signal through a transparent window formed in bottom wall 29 of housing 13).

As referenced briefly above, liquid 23 is an electrically insulating, thermally conductive, and transparent liquid that fills the entirety of interior cavity 15 and envelops light source 17, optical component 19 and power source 21. Accordingly, filling the entirety of cavity 15 with liquid 23 eliminates the presence of air within fixture 11 and some of the shortcomings associated therewith, such as internal pressure fluctuations, condensation and flammability.

It is to be understood that liquid 23 represents any electrically insulating, thermally conductive and transparent liquid. For example, liquid 23 may be in the form of mineral oil, a clear heat stable Phenylmethyl Siloxane (e.g., of the type sold by Dow Corning Corporation of Midland, Mich. as Dow Corning® 550 fluid), or a mixture thereof. However, it should be noted that alternative types of electrically insulating, thermally conductive and transparent liquids could be used for liquid 23 without departing from the spirit of the present invention.

It is also to be understood that the particular type of liquid 23 utilized in the construction of light fixture 11 could be selected based upon certain optical characteristics. As an example, a liquid with particular optical properties could be utilized in order to filter out light that falls outside of a desired wavelength spectrum. As another example, a liquid with particular optical properties (e.g., with an index of refraction in the range between 1.3 and 1.8) could be utilized to direct light emitted by LEDs 43 along a desired path.

As part of the assembly process, cover 27 is fixedly secured to base 25 using fastening elements 33, the presence of compression gaskets 35 creating a watertight seal therebetween. Liquid 23 is then filled into cavity 15 through inlet port 39, with any air present in cavity 15 exiting housing 13 through port 41. Subsequently thereafter, inlet port 39 is preferably sealed closed by any suitable means, such as through the fitted insertion of a screw with external sealant, a gasket, a pipe thread or any combination thereof. As such, it is to be understood that liquid 23 fills the entirety of the empty space within cavity 15 and envelopes all components located therein.

### Operation of Light Fixture 11

Light fixture 11 is designed to operate in the following manner. Specifically, upon completion of its assembly, light fixture 11 is disposed in any environment that requires high power illumination. Activation (i.e., switching) of light fixture 11 is achieved through control port 67, which in turn results in the supply of current to LEDs 43. Upon receiving the necessary current from power source 21, each LED 43 illuminates.

Light emitted from LEDs 43-1 and 43-2 is directed downward and inward towards reflective surface 53 of optical component 19, as represented by arrows A and A′, respectively. The light then reflects off surface 53 and penetrates through light intensifying optical elements 49-1 and 49-2, as represented by arrows B and B′, respectively. As can be seen, the treated light, as represented by arrows B and B′, continues by passing through both transparent liquid 23 and transparent cover 27. In this manner, high power light exits fixture 11 (e.g., as a collimated beam).

It should be noted that any heat generated by LEDs 43-1 and 43-2 is extracted by heat sinks 47-1 and 47-2, respectively, and transferred to thermally conductive liquid 23 that envelopes the exposed parallel fins on each heat sink 47. Due to its thermally conductive nature, liquid 23 effectively transfers heat away from heat sinks 47, or any other heat producing component in cavity 15. In turn, heat is transferred from liquid 23 to at least one of thermally conductive bottom wall 29 and sidewalls 31 (i.e., without the use of an electrically conductive physical path). Any heat retained by base 25 can then be efficiently cooled due to its relatively large, flat, and exposed, exterior surface (i.e., through heat transfer to the surrounding environment, such as ambient air or water). In fact, although not shown herein, base 25 could even be provided with a plurality of flat, parallel fins, or other similar structures, to assist in heat dissipation.

### Features and Advantages of Light Fixture 11

As set forth in detail below, light fixture 11 is constructed with a number of notable design features that enables fixture 11 to produce high power, high quality light in an intrinsically safe and reliable fashion.

As a first feature, light fixture 11 utilizes optical liquid 23, rather than air, to fill the entirety of interior cavity 15. Using a liquid, instead of a gas, to fill enclosed housing 13 eliminates significant fluctuations in internal pressure, since the liquid, by its nature, is non-compressible. By minimizing pressure changes within interior cavity 15, fixture 11 is rendered less susceptible to (i) explosion, (ii) implosion, (iii) internal condensation (e.g., from the drawing of humid external air through its wiring), or (iv) sealant stress and resultant shrinkage. Accordingly, it is to be understood that light fixture 11 could be safely used in a wide range of potential applications, including in high pressure environments (e.g., at significant ocean depths) as well as in hazardous locations with high concentrations of flammable gasses.

As a second feature, light fixture 11 is designed to safely dissipate heat produced therefrom. Specifically, the use of a thermally conductive liquid 23, which envelops all heat producing components, as well as a thermally conductive housing 13 enables heat produced by any component within interior cavity 15, such as light source 17, power source 21 and/or any connective wiring, to be efficiently transferred to thermally conductive base 25. In turn, heat retained by base 25 can be readily cooled by the surrounding environment. Because liquid 23 fills the entirety of interior cavity 15 and is in thermal contact with bottom wall 29 and sidewalls 31, liquid 23 effectively provides three dimensional paths for thermal conduction and thereby efficiently eliminates any hot spots within fixture 11. Consequently, it is to be understood that light fixture 11 could be safely utilized in hazardous locations where high concentrations of flammable gas, vapor or dust are present (e.g., a Zone 0 area), which is an object of the present invention.

As a third feature, light fixture 11 is designed to minimize the risk of short circuits. Specifically, enveloping the various electrical components in light fixture 11 with electrically insulating liquid 23 limits the risk of a shorting condition. As a result, enlarged metal heat sinks 47 can be utilized to dissipate heat without risk of a short circuit or arcing condition with another electrically conductive member (e.g., a wire) in close proximity thereto. Additionally, the minimized risk of shorting enables LEDs 43 to be connected in series, rather than in parallel, which thereby reduces the current requirement for power source 21. For instance, a high power fixture with ten LEDs connected in parallel might require a 150 ampere, 3.5 volt power supply and a high number of corresponding conductive wires, with each LED drawing up to 15 amperes of current. By comparison, connecting the same ten LEDs in series would only require a 15 ampere, 35 volt power supply, which is more a manageable power requirement.

As a fourth advantage, optical liquid 23 provides light fixture 11 with additional means to optimize the quality of light output therefrom. For instance, as noted above, a liquid with particular optical properties could be selected in order to, among other things, (i) filter out light that falls outside of a desired wavelength spectrum, and/or (ii) direct light along a desired path.

### Additional Embodiments and Design Modifications

It is to be understood that the embodiment described in detail above is intended to be merely exemplary and those skilled in the art shall be able to make numerous variations and modifications without departing from the spirit of the present invention. All such variations and modifications are intended to be within the scope of the present invention as defined in the appended claims.

For instance, although light fixture 11 is rendered less susceptible to significant fluctuations in internal pressure than traditional air-filled light fixtures, it is to be understood that light fixture 11 may still experience an implosion or explosion condition when exposed to an extreme variance in temperature. Either of the aforementioned conditions is possible because housing 13, which is preferably constructed of a rigid material, would typically be constructed out of a material with a lower coefficient of thermal expansion than liquid 23, as well as optical component 19.

Specifically, if constructed out of aluminum, housing 13 would experience a 0.59% change in volume over 150 degrees. By comparison, mineral oil and one well known type of Phenylmethyl Siloxane, both of which were suggested above as possible materials for liquid 23, would experience 5.25% and 10.50% changes in volume over 150 degrees, respectively. Furthermore, the use of acrylic for optical component 19 would result in a 1.80% volume change over 150 degrees. As can be appreciated, if housing 13 has a relatively low coefficient of thermal expansion, the volume of interior cavity 15 would not increase to the extent necessary to support the corresponding volumetric expansion of the relatively high coefficient of thermal expansion for liquid 23, as well as any other components disposed in cavity 15.

It is to be understood that the aforementioned problem associated with the mismatch in the coefficient of thermal expansion for the various components of light fixture 11 could be resolved in a couple different ways.

As a first solution, a volumetric compensation element with a lower coefficient of thermal expansion than the coefficient of thermal expansion for housing 13 could be deposited into interior cavity 15 to offset the higher coefficient of thermal expansion of liquid 23. In particular, it is envisioned that silicon sand, glass and quartz, all of which have considerably low coefficients of thermal expansion, could be disposed into interior cavity 15, either as a solid nonfunctional object (e.g., as a block or plate), as a functional component (e.g., as a portion of optical component 19) or in direct communication within liquid 23 (i.e., to form a mixture with liquid 23).

For example, if housing 13 is constructed out of aluminum and defines an interior cavity 15 that is 100 cubic inches in size, a temperature change of 150 degrees would result in a volumetric increase of 0.59 cubic inches. By filing interior cavity 15 with a mixture that consists of 11 cubic inches of mineral oil and 89 cubic inches of quartz, the mineral oil would experience a 0.572 cubic inch increase in volume, whereas the quartz would experience a 0.018 cubic inch increase in volume (based on the coefficient of thermal expansion for each item). Combining the increase in volume of the mineral oil (i.e., 0.572 cubic inches) with the increase in volume of the quartz (i.e., 0.018 cubic inches) would thus equal the 0.572 cubic inch increase in interior cavity 15 due to the expansion of housing 13, thereby minimizing the risk of implosion or explosion of lighting fixture 11.

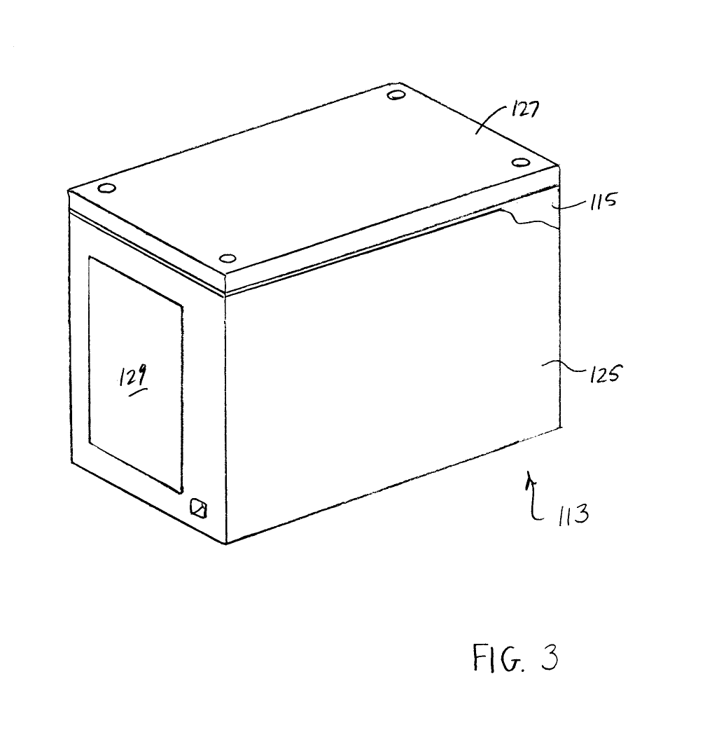

As a second solution, housing 13 could be provided with means to vary the volume of interior cavity 15 to accommodate volumetric changes in the components disposed therein, such as liquid 23. Specifically, referring now to FIG. 3, there is shown a modification to outer housing 13 for light fixture 11, the modified outer housing being identified generally by reference numeral 113.

As can be seen, housing 113 is similar to housing 13 in that outer housing, or casing, 113 includes an open box-shaped base 125 and a removable, generally planar cover 127. Together, base 125 and cover 127 define an enlarged, enclosed, interior cavity 115.

Housing 113 differs primarily from housing 13 in that housing 113 is provided with a deflectable component 129 for selectively adjusting the volume of interior cavity 115 to accommodate for substantial variations in temperature. Specifically, in the present example, deflectable component 129 is represented as a flexible diaphragm, or panel, that is integrated into base 125. Preferably, deflectable component 129 is constructed to be more flexible than the remainder of base 125. The increased flexibility of component 129 can be achieved, for example, by (i) constructing component 129 out of a different material than the remainder of base 125 (e.g., of a resilient, elastic material, such as rubber) or (ii) constructing component 129 with a reduced thickness relative to the remainder of base 125.

In use, component 129 can deflect outward, or expand, to the extent necessary so that the volume of interior cavity 115 increases by the same amount that liquid 23 (and any other components retained within cavity 115) expands in volume due to a change in temperature. Similarly, component 129 can deflect inward, or collapse, to the extent necessary so that the volume of interior cavity 115 decreases by the same amount that liquid 23 (and any other components retained within cavity 115) contracts in volume due to a change in temperature.

It should be noted that deflectable component 129 is not limited to a flexible diaphragm. Rather, it is to be understood that deflectable component 129 represents any structure that can be incorporated into outer housing 113 for selectively modifying the volume of interior cavity 115. For example, although not shown herein, deflectable component 129 could be in the form of a piston, or chamber, that is adapted to either (i) selectively expand or collapse, or (ii) selectively displace, or slide, relative to the remainder of housing 113 (e.g., in the form of a piston that telescopingly displaces in relation to the remainder of housing 113) in response to variations in temperature.

What is claimed is:

1. A lighting fixture, comprising:
(a) a housing shaped to define an interior cavity, the interior cavity having a volume;
(b) a light source for producing light, the light source being disposed within the interior cavity; and
(c) an electrically insulating, thermally conductive, and transparent liquid that substantially fills the interior cavity.

2. The lighting fixture as claimed in claim 1 wherein the interior cavity is fully enclosed by the housing.

3. The lighting fixture as claimed in claim 2 wherein the light source is entirely submerged within the liquid.

4. The lighting fixture as claimed in claim 3 wherein the housing includes a transparent portion that permits the light produced by the light source in the interior cavity to emit therethrough.

5. The lighting fixture as claimed in claim 4 wherein the housing comprises:
(a) a base with a bottom wall and four upstanding sidewalls; and
(b) a cover mounted on the four upstanding sidewalls of the base;
(c) wherein the base and the cover together define the fully enclosed interior cavity.

6. The lighting fixture as claimed in claim 5 wherein the base is at least partially constructed of a rigid, durable and thermally conductive material.

7. The lighting fixture as claimed in claim 6 wherein the cover is at least partially constructed of a rigid, durable and transparent material.

8. The lighting fixture as claimed in claim 5 further comprising at least one gasket disposed between the base and the cover so as to establish a watertight seal therebetween.

9. The lighting fixture as claimed in claim 4 wherein the housing includes a fluid inlet port through which liquid is introduced into the interior cavity.

10. The lighting fixture as claimed in claim 9 wherein the housing includes an air pressure port through which air exits the interior cavity.

11. The lighting fixture as claimed in claim 4 further comprising an optical component disposed within the interior cavity for treating the light produced by the light source.

12. The lighting fixture as claimed in claim 11 wherein the optical component includes at least one bulk optical element fixedly coupled to the housing.

13. The lighting fixture as claimed in claim 11 wherein the optical component includes a reflective surface for directing the light produced by the light source through the transparent portion of the housing.

14. The lighting fixture as claimed in claim 4 further comprising a power source in electrical connection with the light source.

15. The lighting fixture as claimed in claim 14 wherein the power source is mounted on the housing within the interior cavity.

16. The lighting fixture as claimed in claim 15 wherein the housing is shaped to include an enclosed charging port through which the power source can be wirelessly and remotely recharged.

17. The lighting fixture as claimed in claim 15 wherein the housing is shaped to include an enclosed control port through which the power source can be wirelessly and remotely controlled.

18. The lighting fixture as claimed in claim 4 wherein the light source comprises a light emitting diode (LED).

19. The lighting fixture as claimed in claim 18 further comprising a heat sink thermally connected to the light emitting diode, the heat sink being submerged entirely in the liquid.

20. The lighting fixture as claimed in claim 4 wherein the liquid comprises at least one mineral oil and Phenylmethyl Siloxane.

21. The lighting fixture as claimed in claim 20 wherein the liquid has an index of refraction in the range between 1.3 and 1.8.

22. The lighting fixture as claimed in claim 2 wherein the housing includes a deflectable component for selectively modifying the volume of the interior cavity.

23. The lighting fixture as claimed in claim 22 wherein the deflectable component is in the form of a flexible diaphragm for selectively modifying the volume of the interior cavity.

24. The lighting fixture as claimed in claim 5 wherein the base of the housing is constructed of a first material with a first coefficient of thermal expansion, and wherein a volumetric compensation element is deposited into the interior cavity, the volumetric compensation element being constructed of a second material with a second coefficient of thermal expansion, the second coefficient of thermal expansion being lower than the first coefficient of thermal expansion.
